(19) United States
(12) Patent Application Publication
(10) Pub. No.: US 2015/0309663 A1
(43) Pub. Date: Oct. 29, 2015

(54) FLEXIBLE AIR AND SURFACE MULTI-TOUCH DETECTION IN MOBILE PLATFORM

(71) Applicant: QUALCOMM Incorporated, San Diego, CA (US)

(72) Inventors: Hae-Jong Seo, San Jose, CA (US); John Michael Wyrwas, Berkeley, CA (US); Jacek Maitan, Mountain View, CA (US); Evgeni Petrovich Gousev, Saratoga, CA (US); Babak Aryan, San Diego, CA (US); Xiquan Cui, San Jose, CA (US)

(21) Appl. No.: 14/546,303

(22) Filed: Nov. 18, 2014

Related U.S. Application Data
(60) Provisional application No. 61/985,423, filed on Apr. 28, 2014.

(51) Int. Cl. G06F 3/042; G06F 3/0354; G06T 7/00; G06F 3/01

(52) U.S. Cl. CPC G06F 3/0421; G06F 3/017; G06F 3/03545; G06T 7/0051; G06F 2203/04101

(57) ABSTRACT

Systems, methods, and apparatus for recognizing user interactions with an electronic device are provided. Implementations of the systems, methods, and apparatus include surface and air gesture recognition and identification of fingertips or other objects. In some implementations, a device including a plurality of detectors configured to receive signals indicating interaction of an object with the device at or above a detection area, such that a low resolution image can be generated from the signals, is provided. The device is configured to obtain low resolution image data from the signals and obtain a first reconstructed depth map from the low resolution image data. The first reconstructed depth map may have a higher resolution than the low resolution image. The device is further configured to obtain a second reconstructed depth map from the first reconstructed depth map. The second reconstructed depth map may provide improved boundaries and less noise within the object.

### CROSS REFERENCE TO RELATED APPLICATION

This application claims benefit of priority under 35 U.S.C. §119(e) to U.S. Provisional Patent Application No. 61/985,423, filed Apr. 28, 2014, which is incorporated by reference herein in its entirety and for all purposes.

### TECHNICAL FIELD

This disclosure relates generally to input systems suitable for use with electronic devices, including display devices. More specifically, this disclosure relates to input systems capable of recognizing surface and air gestures and fingertips.

### DESCRIPTION OF THE RELATED TECHNOLOGY

Projected capacitive (PCT) is currently the most widely used touch technology in mobile displays with high image clarity and input accuracy. However, PCT has challenges of scaling up, due to limitations of power consumption, response time and production cost. In addition, this technology generally requires users to touch the screen to make the system responsive. Camera-based gesture recognition technology has advanced in recent years with efforts to create more natural user interfaces that go beyond touch screens for smartphones and tablets. However, gesture recognition technology has not become mainstream in mobile devices due to the constraints of power, performance, cost and usability challenges including fast response, recognition accuracy and robustness with respect to noise. Further, cameras have a limited field of view with dead zones near the screen. As a result, camera-based gesture recognition performance deteriorates as gestures get closer to the screen.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including an interface for a user of an electronic device, the interface having a front surface including a detection area; a plurality of detectors configured to detect interaction of an object with the device at or above the detection area and to output signals indicating the interaction such that an image can be generated from the signals; and a processor configured to: obtain image data from the signals, apply a linear regression model to the image data to obtain a first reconstructed depth map, and apply a trained non-linear regression model to the first reconstructed depth map to obtain a second reconstructed depth map. In some implementations, the first reconstructed depth map has a higher resolution than that of the image.

In some implementations, the apparatus may include one or more light-emitting sources configured to emit light. The plurality of detectors can be light detectors such that the signals indicate interaction of the object with light emitted from the one or more light-emitting sources. In some implementations, the apparatus may include a planar light guide disposed substantially parallel to the front surface of the interface, the planar light guide including: a first light-turning arrangement configured to output reflected light, in a direction having a substantial component orthogonal to the front surface, by reflecting emitted light received from one or more light-emitting sources; and a second light-turning arrangement that redirects light resulting from the interaction toward the plurality of detectors.

The second reconstructed depth map may have a resolution at least three times greater than the resolution of the image. In some implementations, the second reconstructed depth map has the same resolution as the first reconstructed depth map. The processor may be configured to recognize, from the second reconstructed depth map, an instance of a user gesture. In some implementations, the interface is an interactive display and the processor is configured to control one or both of the interactive display and the electronic device, responsive to the user gesture. Various implementations of the apparatus disclosed herein do not include a time-of-flight depth camera.

In some implementations, obtaining image data can include vectorization of the image. In some implementations, obtaining a first reconstructed depth map includes applying a learned weight matrix to vectorized image data to obtain a first reconstructed depth map matrix. In some implementations, applying a non-linear regression model to the first reconstructed depth map includes extracting a multi-pixel patch feature for each pixel of the first reconstructed depth map to determine a depth map value for each pixel.

In some implementations, the object is a hand. In such implementations, the processor may be configured to apply a trained classification model to the second reconstructed depth map to determine locations of fingertips of the hand. The locations may include translation and depth location information. In some implementations, the object can be a stylus.

Another innovative aspect of the subject matter described in this disclosure can be implemented in an apparatus including an interface for a user of an electronic device having a front surface including a detection area; a plurality of detectors configured to receive signals indicating interaction of an object with the device at or above the detection area, wherein an image can be generated from the signals; and a processor configured to: obtain image data from the signals, obtain a first reconstructed depth map from the image data, wherein the first reconstructed depth map has a higher resolution than the image, and apply a trained non-linear regression model to the first reconstructed depth map to obtain a second reconstructed depth map.

Another innovative aspect of the subject matter described in this disclosure can be implemented in a method including obtaining image data from a plurality of detectors arranged along a periphery of a detection area of a device, the image data indicating an interaction of an object with the device at or above the detection area; obtaining a first reconstructed depth map from the image data; and obtaining a second reconstructed depth map from the first reconstructed depth map. The first reconstructed depth map may have a higher resolution than the image data obtained from the plurality of detectors.

In some implementations, obtaining the first reconstructed depth map includes applying a learned weight matrix to vectorized image data. The method can further include learning the weight matrix. Learning the weight matrix can include obtaining training set data of pairs of high resolution depth maps and low resolution images for multiple object gestures and positions. In some implementations, obtaining a second reconstructed depth map includes applying a non-linear regression model to the first reconstructed depth map. Applying a non-linear regression model to the first reconstructed depth map may include extracting a multi-pixel patch feature for each pixel of the first reconstructed depth map to determine a depth map value for each pixel.

In some implementations, the object may be a hand. The method can further include applying a trained classification model to the second reconstructed depth map to determine locations of fingertips of the hand. Such locations may include translation and depth location information.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration of a mobile electronic device configured for air and surface gesture detection.

FIGS. 2A-2D show various views of an example of a device configured to generate low resolution image data.

FIG. 3 shows an example of a device configured to generate low resolution image data.

FIG. 4 shows an example of a flow diagram illustrating a process for obtaining a high resolution reconstructed depth map from low resolution image data.

FIG. 5 shows an example of a flow diagram illustrating a process for obtaining a first reconstructed depth map from low resolution image data.

FIG. 6 shows an example of a flow diagram illustrating a process for obtaining a second reconstructed depth map from a first reconstructed depth map.

FIG. 7 shows an example of low resolution images of a three-finger gesture at various distances (0 mm, 20 mm, 40 mm, 60 mm, 80 mm and 100 mm) from the surface of a device.

FIG. 8 shows an example of a flow diagram illustrating a process for obtaining a linear regression model.

FIG. 9 shows an example of a flow diagram illustrating a process for obtaining a non-linear regression model.

FIG. 10 shows an example of a schematic illustration of a reconstructed depth map and multiple pixel patches.

FIG. 11 shows an example of a flow diagram illustrating a process for obtaining fingertip location information from low resolution image data.

FIG. 12 shows an example of images from different stages of fingertip detection.

FIG. 13 shows an example of a flow diagram illustrating a process for obtaining a non-linear classification model.

FIG. 14 shows an example of a block diagram of an electronic device having an interactive display according to an implementation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system utilizing a touch input interface (including in devices that utilize touch input for purposes other than touch input for a display). In addition, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, and aesthetic structures (such as display of images on a piece of jewelry or clothing. Thus, the teachings are not intended to be limited to the implementations depicted solely in the Figures, but instead have wide applicability as will be readily apparent to one having ordinary skill in the art.

Implementations described herein relate to apparatuses, such as touch input devices, that are configured to sense objects at or above an interface of the device. The apparatuses include detectors configured to detect interaction of an object with the device at or above the detection area and output signals indicating the interaction. The apparatuses can include a processor configured to obtain low resolution image data from the signals and, from the low resolution image data, obtain an accurate high resolution reconstructed depth map. In some implementations, objects such as fingertips may be identified. The processor may be further configured to recognize instances of user gestures from the high resolution depth maps and object identification.

Particular implementations of the subject matter described in this disclosure can be implemented to realize one or more of the following potential advantages. In some implementations, depth map information of user interactions can be obtained by an electronic device without incorporating bulky and expensive hardware into the device. Depth maps having high accuracy may be generated, facilitating multiple fingertip detection and gesture recognition. Accurate fingertip or other object detection can be performed with low power consumption. In some implementations, the apparatuses can detect fingertips or gestures at or over any part of a detection area including in areas that are inaccessible to alternative gesture recognition technologies. For example, the apparatuses can detect gestures in areas that are dead zones for camera-based gesture recognition technologies due to the conical view of cameras. Further, implementations of the subject matter described in this disclosure may detect fingertips or gestures at the surface of an electronic device as well as above the electronic device.

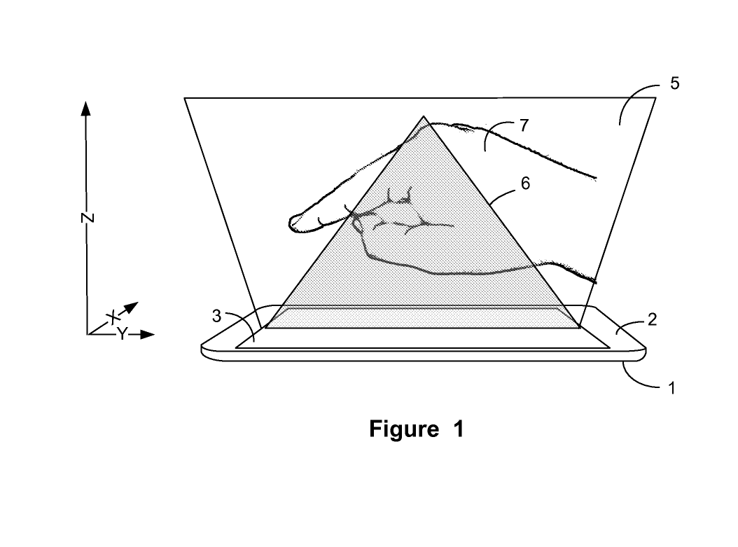

FIG. 1 shows an example of a schematic illustration of a mobile electronic device configured for air and surface gesture detection. The mobile electronic device 1 includes a first surface 2 including a detection area 3. In the example of FIG. 1, the detection area 3 is an interactive display of the mobile electronic device 1. A processor (not shown) may be configured to control an output of the interactive display, responsive, at least in part to user inputs. At least some of the user inputs may be made by way of gestures, which include gross motions of a user's appendage, such as a hand or a finger, a stylus of a handheld object or the like. In the example of FIG. 1, a hand 7 is shown.

The mobile electronic device 1 may be configured for both surface (touch) and air (non-contact) gesture recognition. An area 5 (which represents a volume) in the example of FIG. 1 extends a distance in the z-direction above the first surface 2 of the mobile electronic device 1 that is configured to recognize gestures. The area 5 includes an area 6 that is a dead zone for camera-based gesture recognition. Thus, the mobile electronic device 1 is capable of recognizing gestures in the area 6, where current camera-based gesture recognition systems do not recognize gestures. Shape and depth information of the hand or other object may be compared with an expression vocabulary to recognize gestures.

The apparatus and methods disclosed herein can have, for example, z-direction recognition distance or depth of up to about 20-40 cm or even greater from the surface (of, for example, an interactive display of a mobile electronic device), depending on the sensor system employed and depending upon the feature being recognized or tracked. For example, for fingertip detection and tracking (for fingertip-based gestures), z-direction recognition distances or depths of up to about 10-15 cm or even greater are possible. For detection and tracking of the entire palm or hand, for example for a hand-swipe gesture, z-direction recognition distances or depths of up to 30 cm or even greater are possible. As described above with reference to FIG. 1, the apparatus and methods may be capable of recognizing any object in the entire volume over the device from 0 cm (at the surface) to the recognition distance.

It should be noted however, that the apparatus and methods may be employed with sensor systems having any z-direction capabilities, including for example, PCT systems. Further, implementations may be employed with surface-only sensor systems.

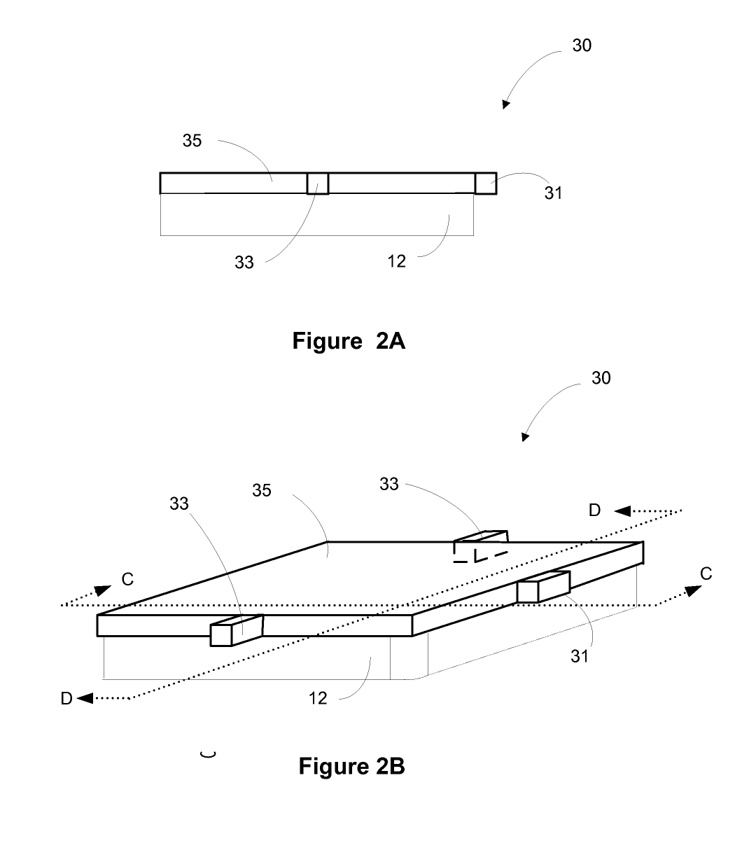

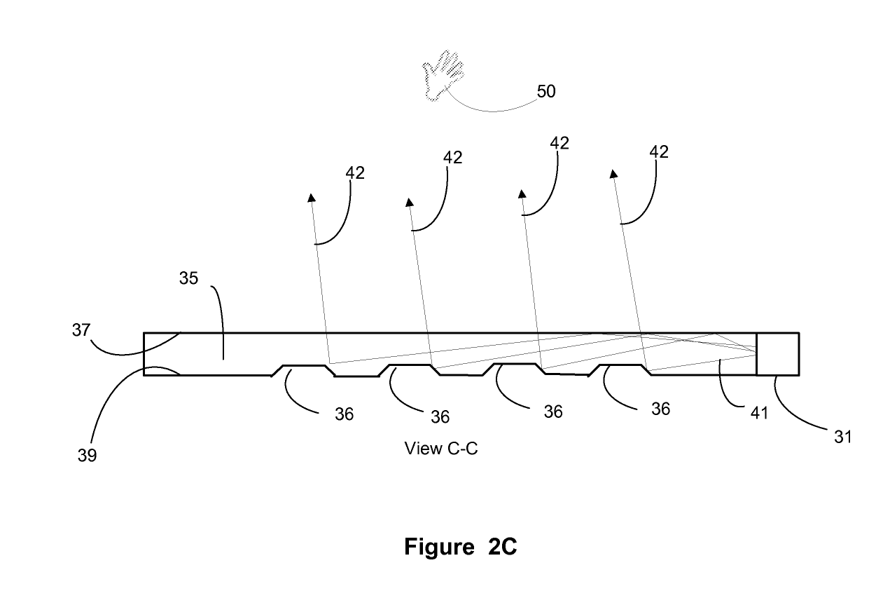

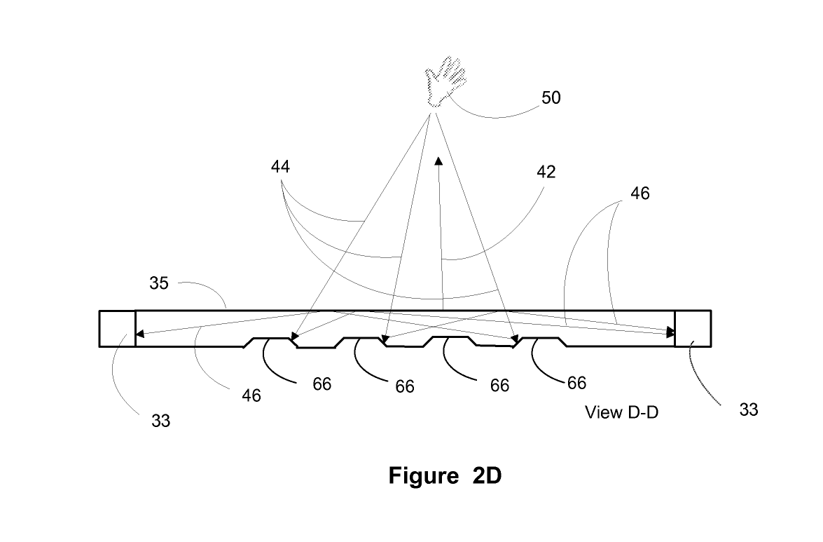

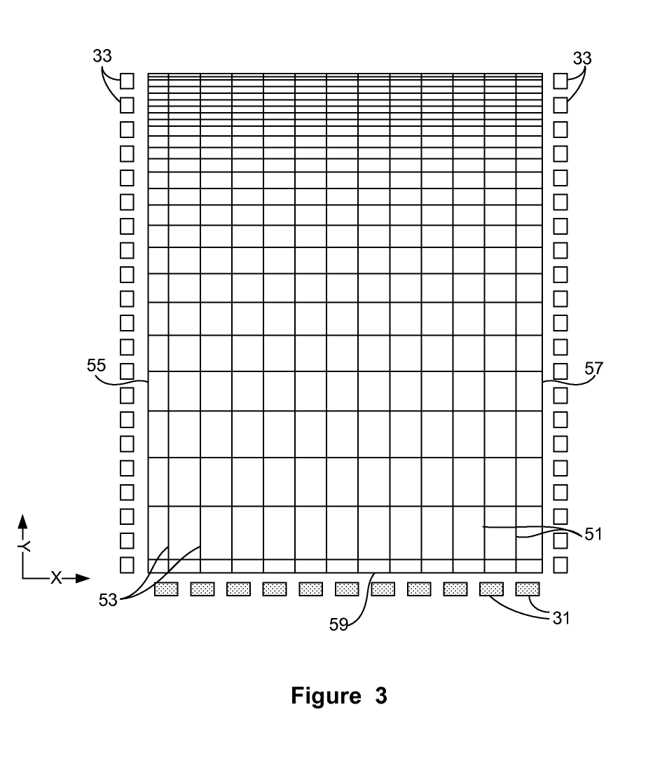

The apparatus and methods disclosed herein use low resolution image data. The low resolution image data is not limited to any particular sensor data but may include image data generated from photodiodes, phototransistors, charge coupled device (CCD) arrays, complementary metal oxide semiconductor (CMOS) arrays or other suitable devices operable to output a signal representative of a characteristic of detected visible, infrared (IR) and/or ultraviolet (UV) light. Further, the low resolution image data may be generated from non-light sensors including capacitance sensing mechanisms in some implementations. In some implementations, the sensor system includes a planar detection area having sensors along one or more edges of the detection area. Examples of such systems are described below with respect to FIGS. 2A-2D and 3.

It should be noted that the low resolution image data from which depth maps may be reconstructed are not depth map image data. While some depth information may be implicit in the data (e.g., signal intensity may correlate with distance from the surface), the low resolution image data does not include distance information itself. As such, the methods disclosed herein are distinct from various methods in which depth map data (for example, an initial depth map generated from a monocular image) is improved on using techniques such as bilateral filtering. Further, in some implementations, the resolution of the low resolution image data may be considerably lower than that a bilateral filtering technique may use. Such a technique may employ an image having a resolution of at least 100×100, for example. While the methods and apparatus disclosed herein can be implemented to obtain a reconstructed depth map from a 100×100 or higher resolution image, in some implementations, low resolution image data used in the apparatus and methods described herein may be less than 50×50 or even less than 30×30.

The resolution of the image obtained may depend on the size and aspect ratio of the device. For example, for a device having an aspect ratio of about 1.8, the resolution of a low resolution image may be less than 100×100, less than 100×55, less than 60×33, or less than 40×22, in some implementations.

Resolution may also be characterized in terms of pitch, i.e., the center-to-center distance between pixels, with a larger pitch corresponding to a smaller resolution. For example, for a device such as a mobile phone having dimensions of a 111 mm×51 mm, a pitch of 3 mm corresponds to a resolution of 37×17. An appropriate pitch may be selected based on the size of an object to be recognized. For example, for finger recognition, a pitch of 5 mm may be appropriate. A pitch of 3 mm, 1 mm, 0.5 mm or less may be appropriate for detection of a stylus, for example.

It will be understood that the methods and apparatus disclosed herein may be implemented using low resolution data having higher resolutions and smaller pitches than described above. For example, devices having larger screens may have resolutions of 200×200 or greater. For any resolution or pitch, the methods and apparatus disclosed herein may be implemented to obtain higher resolution reconstructed depth maps.

FIGS. 2A-2D show an example of a device configured to generate low resolution image data. FIGS. 2A and 2B show an elevation view and a perspective view, respectively, of an arrangement 30 including a light guide 35, a light-emitting source 31, and light sensors 33 according to an implementation. Although illustrated only along a portion of a side or edge of the light guide 35, it is understood that the source may include an array of light-emitting sources 31 disposed along the edge of light guide 35. FIG. 2C shows an example of a cross section of the light guide as viewed from a line parallel to C-C of FIG. 2B and FIG. 2D shows an example of a cross section of the light guide as viewed from a line parallel to D-D of FIG. 2B. Referring to FIGS. 2A and 2B, the light guide 35 may be disposed above and substantially parallel to the front surface of an interactive display 12. In the illustrated implementation, a perimeter of the light guide 35 is substantially coextensive with a perimeter of the interactive display 12. According to various implementations, the perimeter of the light guide 35 can be coextensive with, or larger than and fully envelop, the perimeter of the interactive display 12. The light-emitting source 31 and the light sensors 33 may be disposed proximate to and outside of the periphery of the light guide 35. The light-emitting source 31 may be optically coupled with an input of the light guide 35 and may be configured to emit light toward the light guide 35 in a direction having a substantial component parallel to the front surface of interactive display 12. In other implementations, a plurality of light-emitting sources 31 are disposed along the edge of the light guide 35, each sequentially illuminating a column-like or row-like area in the light guide for a short duration. The light sensors 33 may be optically coupled with an output of the light guide 35 and may be configured to detect light output from the light guide 35 in a direction having a substantial component parallel to the front surface of interactive display 12.

In the illustrated implementation, two light sensors 33 are provided; however, more light sensors may be provided in other implementations as discussed further below with reference to FIG. 3. The light sensors 33 may include photosensitive elements, such as photodiodes, phototransistors, charge coupled device (CCD) arrays, complementary metal oxide semiconductor (CMOS) arrays or other suitable devices operable to output a signal representative of a characteristic of detected visible, infrared (IR) and/or ultraviolet (UV) light. The light sensors 33 may output signals representative of one or more characteristics of detected light. For example, the characteristics may include intensity, directionality, frequency, amplitude, amplitude modulation, and/or other properties.

In the illustrated implementation, the light sensors 33 are disposed at the periphery of the light guide 35. However, alternative configurations are within the contemplation of the present disclosure. For example, the light sensors 33 may be remote from the light guide 35, in which case light detected by the light sensors 33 may be transmitted from the light guide 35 by additional optical elements such as, for example, one or more optical fibers.

In an implementation, the light-emitting source 31 may be one or more light-emitting diodes (LED) configured to emit primarily infrared light. However, any type of light source may be used. For example, the light-emitting source 31 may include one or more organic light emitting devices (“OLEDs”), lasers (for example, diode lasers or other laser sources), hot or cold cathode fluorescent lamps, incandescent or halogen light sources. In the illustrated implementation, the light-emitting source 31 is disposed at the periphery of the light guide 35. However, alternative configurations are within the contemplation of the present disclosure. For example, the light-emitting source 31 may be remote from the light guide 35 and light produced by the light-emitting source 31 may be transmitted to light guide 35 by additional optical elements such as, for example, one or more optical fibers, reflectors, etc. In the illustrated implementation, one light-emitting source 31 is provided; however, two or more light-emitting sources may be provided in other implementations.

FIG. 2C shows an example of a cross section of the light guide 35 as viewed from a line parallel to C-C of FIG. 2B. For clarity of illustration, the interactive display 12 is omitted from FIG. 2C. The light guide 35 may include a substantially transparent, relatively thin, overlay disposed on, or above and proximate to, the front surface of the interactive display 12. In one implementation, for example, the light guide 35 may be approximately 0.5 mm thick, while having a planar area in an approximate range of tens or hundreds of square centimeters. The light guide 35 may include a thin plate composed of a transparent material such as glass or plastic, having a front surface 37 and a rear surface 39, which may be substantially flat, parallel surfaces.

The transparent material may have an index of refraction greater than 1. For example, the index of refraction may be in the range of about 1.4 to 1.6. The index of refraction of the transparent material determines a critical angle ‘α’ with respect to a normal of front surface 37 such that a light ray intersecting front surface 37 at an angle less than ‘α’ will pass through front surface 37 but a light ray having an incident angle with respect to front surface 37 greater than ‘α’ will undergo total internal reflection (TIR).

In the illustrated implementation, the light guide 35 includes a light-turning arrangement that reflects emitted light 41 received from light-emitting source 31 in a direction having a substantial component orthogonal to the front surface 37. More particularly, at least a substantial fraction of reflected light 42 intersects the front surface 37 at an angle to the normal that is less than critical angle ‘α’. As a result, such reflected light 42 does not undergo TIR, but instead may be transmitted through the front surface 37. It will be appreciated that the reflected light 42 may be transmitted through the front surface 37 at a wide variety of angles.

In an implementation, the light guide may have a light-turning arrangement that includes a number of reflective microstructures 36. The microstructures 36 can all be identical, or have different shapes, sizes, structures, etc., in various implementations. The microstructures 36 may redirect emitted light 41 such that at least a substantial fraction of reflected light 42 intersects the front surface 37 at an angle to normal less than critical angle ‘α’.

FIG. 2D shows an example of a cross section of the light guide as viewed from a line parallel to D-D of FIG. 2B. For clarity of illustration, the interactive display 12 is omitted from FIG. 2D. As illustrated in FIG. 2D, when the object 50 interacts with the reflected light 42, scattered light 44, resulting from the interaction, may be directed toward the light guide 35. The light guide 35 may, as illustrated, include a light-turning arrangement that includes a number of reflective microstructures 66. The reflective microstructures 66 may be configured similarly as reflective microstructures 36, or be the same physical elements, but this is not necessarily so. In some implementations, the reflective microstructures 66 are configured to reflect light toward light sensors 33, while the reflective microstructures 36 are configured to reflect light from light source 31 and eject the reflected light out of the light guide. If reflective microstructures 66 and reflective microstructures 36 have a particular orientation, it is understood that reflective microstructures 66 and reflective microstructures 36 may, in some implementations, be generally perpendicular to each other.

As illustrated in FIG. 2D, when the object 50 interacts with the reflected light 42, the scattered light 44, resulting from the interaction, may be directed toward the light guide 35. The light guide 35 may be configured to collect scattered light 44. The light guide 35 includes a light-turning arrangement that redirects the scattered light 44, collected by the light guide 35 toward one or more of the light sensors 33. The redirected collected scattered light 46 may be turned in a direction having a substantial component parallel to the front surface of the interactive display 12. More particularly, at least a substantial fraction of the redirected collected scattered light 46 intersects the front surface 37 and the back surface 39 only at an angle to normal greater than critical angle ‘α’ and, therefore, undergoes TIR. As a result, such redirected collected scattered light 46 does not pass through front surface 37 or the back surface 39 and, instead, reaches one or more of the light sensors 33. Each of the light sensors 33 may be configured to detect one or more characteristics of the redirected collected scattered light 46, and output, to a processor, a signal representative of the detected characteristics. For example, the characteristics may include intensity, directionality, frequency, amplitude, amplitude modulation, and/or other properties.

FIG. 3 shows another example of a device configured to generated low resolution image data. The device in the example of FIG. 3 includes a light guide 35, a plurality of light sensors 33 distributed along opposite edges 55 and 57 of the light guide 35, and a plurality of light sources 31 distributed along an edge 59 of the light guide that is orthogonal to the edges 55 and 57. Also depicted in the example of FIG. 3 are emission troughs 51 and collection troughs 53. The emission troughs 51 are light-turning features such as the reflective microstructures 36 depicted in FIG. 2C that may direct light from the light sources 31 through the front surface of the light guide 35. The collection troughs 53 are light turning features such as the reflective microstructures 66 depicted in FIG. 2D that may direct light from an object to the light sensors 33. In the example of FIG. 3, the emission troughs 51 are spaced such that the spacing of the troughs gets closer as the light emitted by the light sources 51 attenuates to account for the attenuation. In some implementations, the light sources 31 may be turned on sequentially to provide x-coordinate information sequentially, with the corresponding y-coordinate information provided by the pair of light sensors 33 at each y-coordinate. Apparatus and methods employing time-sequential measurements that may be implemented with the disclosure provided herein are described in U.S. patent application Ser. No. 14/051,044, “Infrared Touch And Hover System Using Time-Sequential Measurements,” filed Oct. 10, 2013 and incorporated by reference herein. In the example of FIG. 3, there are twenty-one light sensors 33 along each of the edges 55 and 57 and eleven light sources 31 along the edge 59 to provide a resolution of 21×11.

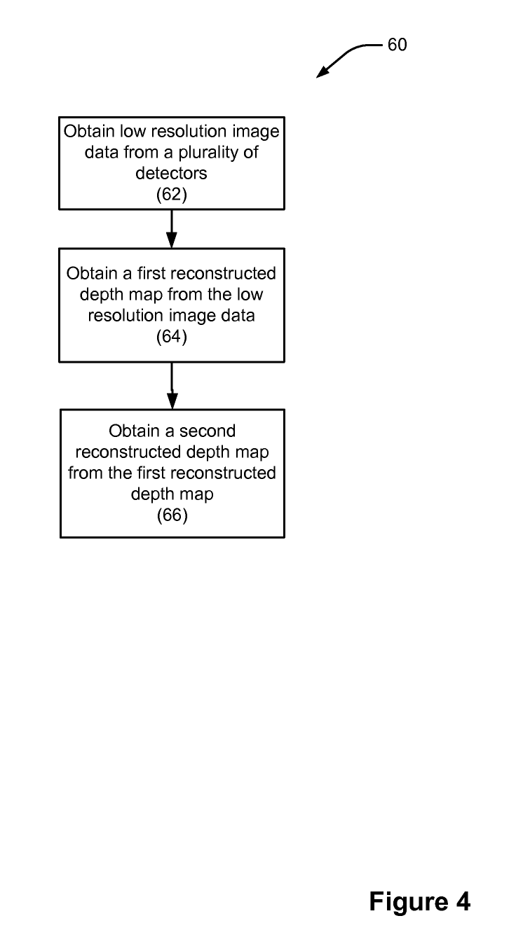

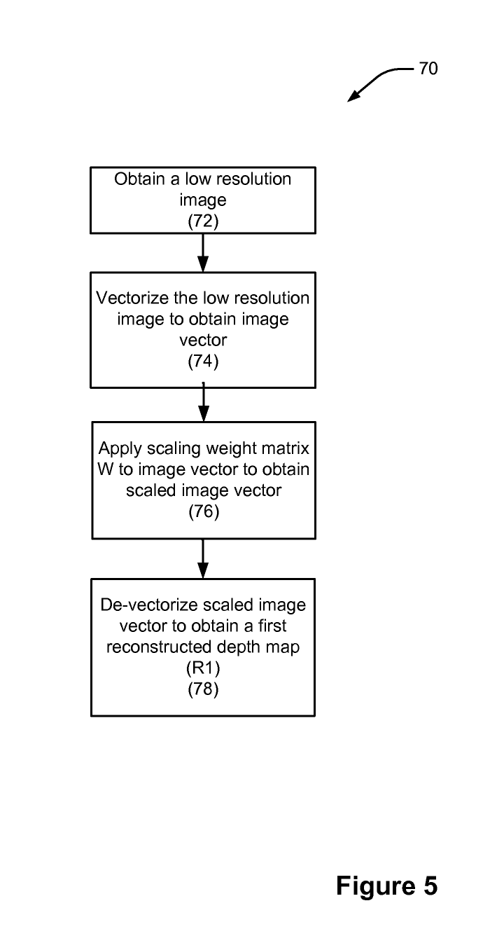

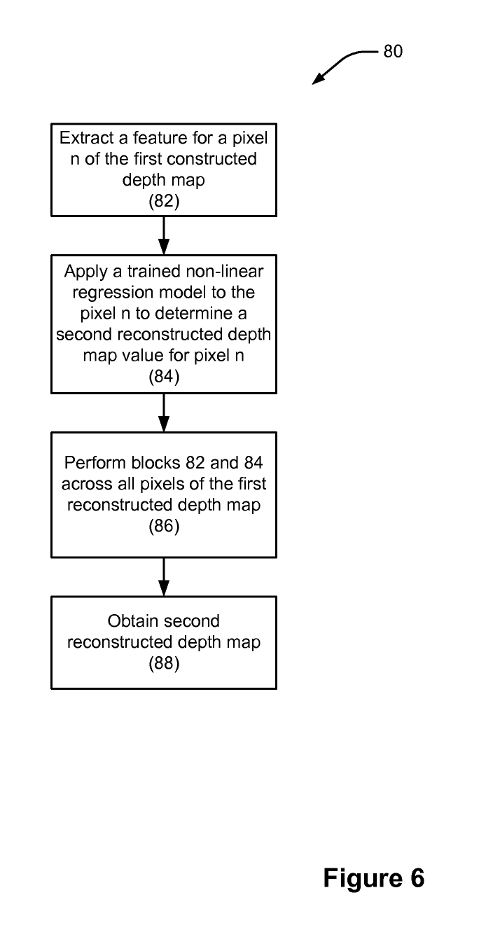

FIG. 4 shows an example of a flow diagram illustrating a process for obtaining a high resolution reconstructed depth map from low resolution image data. An overview of a process according to some implementations is given in FIG. 4, with examples of specific implementations described further below with reference to FIGS. 5 and 6. The process 60 begins at block 62 with obtaining low resolution image data from a plurality of detectors. The apparatus and methods described herein may be implemented with any system that can generate low resolution image data. The devices described above with reference to FIGS. 2A-2D and 3 are examples of such systems. Further examples are provided in U.S. patent application Ser. No. 13/480,377, “Full Range Gesture System,” filed May 23, 2012, and U.S. patent application Ser. No. 14/051,044, “Infrared Touch And Hover System Using Time-Sequential Measurements,” filed Oct. 10, 2013, both of which are incorporated by reference herein in their entireties.

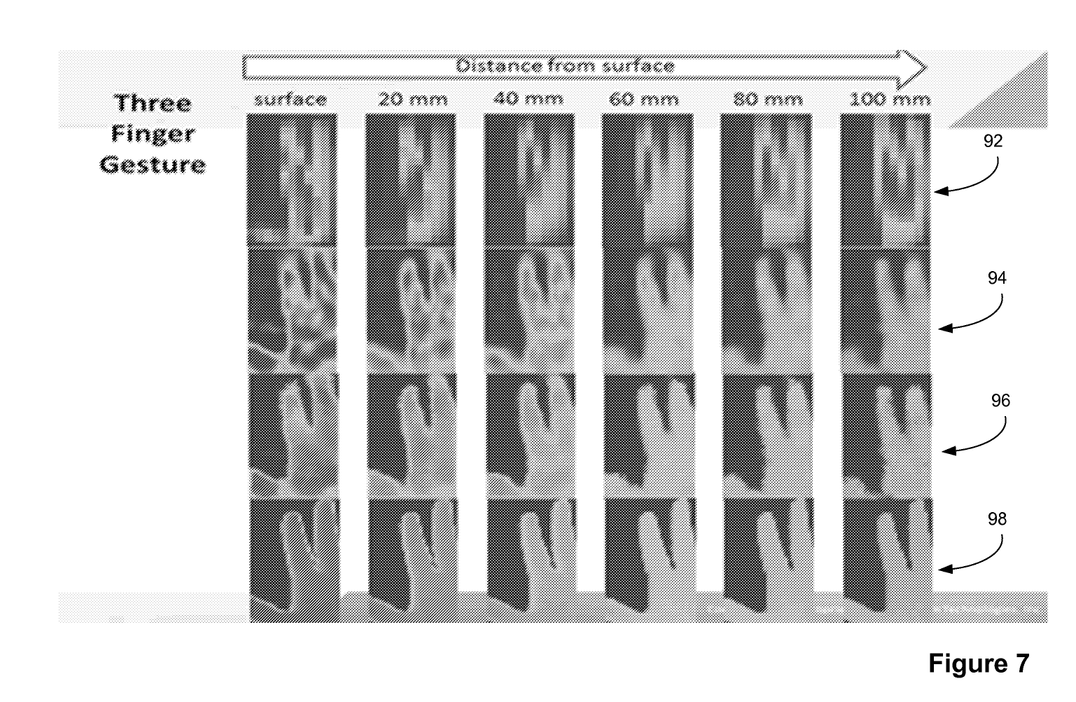

In some implementations, the low resolution image data may include information that identifies image characteristics at x-y locations within the image. FIG. 7 shows an example of low resolution images 92 of a three-finger gesture at various distances (0 mm, 20 mm, 40 mm, 60 mm, 80 mm and 100 mm) from the surface of a device. Object depth is represented by color (seen as darker and lighter tones in the grey scale image). In the example of FIG. 7, the low resolution images have a resolution of 21×11.

The process 60 continues at block 64 with obtaining a first reconstructed depth map from the low resolution image data. The reconstructed depth map contains information relating to the distance of the surfaces of the object from the surface of the device. Block 64 may upscale and retrieve notable object structure from the low resolution image data, with the first reconstructed depth map having a higher resolution than the low resolution image corresponding to the low resolution image data. In some implementations, the first reconstructed depth map has a resolution corresponding to the final desired resolution. According to various implementations, the first reconstructed depth map may have a resolution at least about 1.5 to at least about 6 times higher than the low resolution image. For example, the first reconstructed depth map may have a resolution at least about 3 or 4 times higher than the low resolution image. Block 64 can involve obtaining a set of reconstructed depth maps corresponding to sequential low resolution images.

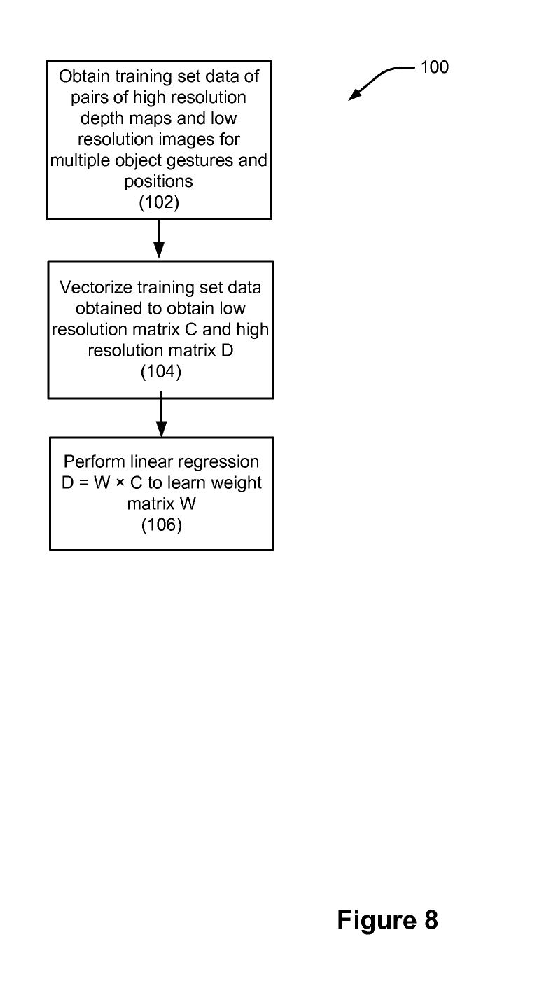

Block 64 may involve applying a learned regression model to the low resolution image data obtained in block 62. As described further below with reference to FIG. 5, in some implementations, a learned linear regression model is applied. FIG. 8, also described further below, provides an example of learning a linear regression model that may be applied in block 64. FIG. 7 shows an example of first reconstructed depth maps 94 corresponding to the low resolution images 92. The first reconstructed depth maps 94, reconstructed from the low resolution image data used to generated low resolution images 92, have a resolution of 131×61.

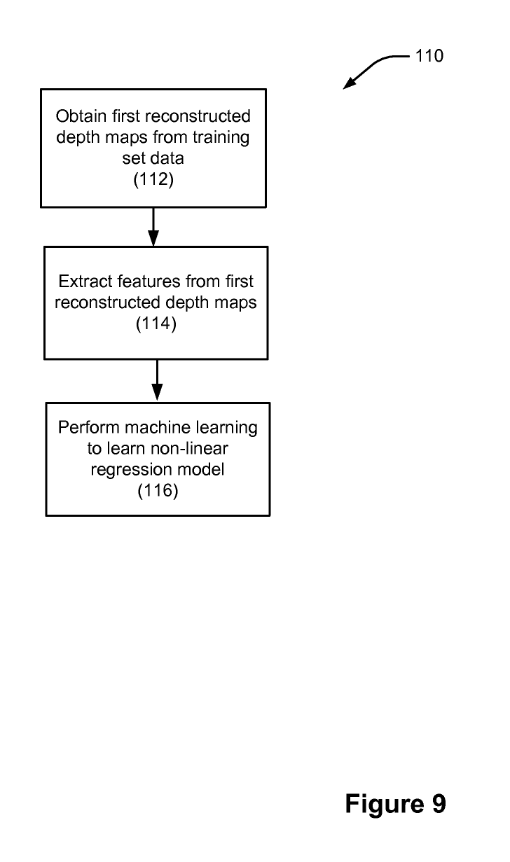

Returning to FIG. 4, the process continues at block 66 by obtaining a second reconstructed depth map from the first reconstructed depth map. The second reconstructed depth map may provide improved boundaries and less noise within the object. Block 66 may involve applying a trained non-linear regression model to the first reconstructed depth map to obtain the second reconstructed depth map. For example, a random forest model, a neural network model, a deep learning model, a support vector machine model or other appropriate model may be applied. FIG. 6 provides an example of applying a trained non-linear regression model, with FIG. 9 providing an example of training a non-linear regression model that may be applied in block 66. As in block 64, block 66 can involve obtaining a set of reconstructed depth maps corresponding to sequential low resolution images.

In some implementations, a relatively simple trained non-linear regression model may be applied. In one example, an input layer of a neural network regression may include a 5×5 patch from a first reconstructed depth map, such that the size of the input layer is 25. A hidden layer of size 5 may be used to output a single depth map value.

FIG. 7 shows an example of second reconstructed depth maps 96 at various distances from the surface of a device, reconstructed from first reconstructed depth maps 94. The first reconstructed depth maps 96 have a resolution of 131×61, the same as the first reconstructed depth maps 94 but have improved accuracy. This can be seen by comparing the first reconstructed depth maps 94 and the second reconstructed depth maps 96 to ground truth depth maps 98 generated from a time-of-flight camera. The first reconstructed depth maps 94 are less uniform than the second reconstructed depth maps 96, with some inaccurate variation in depth values within the hand observed. As can be seen from the comparison, the second reconstructed depth maps 96 are more similar to the ground truth depth maps 98 than the first reconstructed depth maps 94. The process 60 can effectively overcome the deficiencies of low quality images without expensive, bulky and power consuming hardware to produce accurate reconstructed depth maps. FIG. 5 shows an example of a flow diagram illustrating a process for obtaining a first reconstructed depth map from low resolution image data. The process 70 begins at block 72 with obtaining a low resolution image as input. Examples of low resolution images are shown in FIG. 7 as describe above. The process 70 may continue at block 74 with vectorizing the low resolution image 74 to obtain an image vector. The image vector includes values representing signals as received from the detector (for example, current from photodiodes) for the input image. In some implementations, blocks 72 and 74 may not be performed, if for example, the low resolution image data is provided in vector form. The process 70 continues at block 76 with applying a scaling weight matrix W to the image vector. The scaling weight matrix W represents the learned linear relationship between low resolution images and the high resolution depth maps generated from the time-of-flight camera data that was obtained from the training described below. The result is a scaled image vector. The scaled image vector may include values from 0 to 1 representing grey scale depth map values. The process 70 may continue at block 78 by de-vectorizing the scaled image vector to obtain a first reconstructed depth map (R1). Block 78 can involve obtaining a set of first reconstructed depth maps corresponding to sequential low resolution images. Examples of first reconstructed depth maps are shown in FIG. 7 as described above.

FIG. 6 shows an example of a flow diagram illustrating a process for obtaining a second reconstructed depth map from a first reconstructed depth map. As described above, this can involve applying a non-linear regression model to the first reconstructed depth map. The non-linear regression model may be obtained as described above. The process 80 begins at block 82 by extracting a feature for a pixel n of the first reconstructed depth map. In some implementations, the features of the non-linear regression model can be multi-pixel patches. For example, the features may be 7×7 pixel patches. The multi-pixel patch may be centered on the pixel n. The process 80 continues at block 84 with applying a trained non-linear model to the pixel n to determine a regression value for the pixel n. The process 80 continues at block 86 by performing blocks 82 and 84 across all pixels of the first reconstructed depth map. In some implementations, block 86 may involve a sliding window or raster scanning technique, though it will be understood that other techniques may also be applied. Applying blocks 82 and 84 pixel-by-pixel across all pixels of the first reconstructed depth map results in an improved depth map of the same resolution as the first reconstructed depth map. The process 80 continues at block 88 by obtaining the second reconstructed depth map from the regression values obtained in block 84. Block 88 can involve obtaining a set of second reconstructed depth maps corresponding to sequential low resolution images. Examples of second reconstructed depth maps are shown in FIG. 7 as described above.

The processes described above with reference to FIGS. 4-6 involve applying learned or trained linear and non-linear regression models. In some implementations, the models may learned or trained using a training set including pairs of depth maps of an object and corresponding sensor images of the object. The training set data may be obtained by obtaining low resolution sensor images and depth maps for an object in various gestures and positions, including translational locations, rotational orientations, and depths (distances from the sensor surface). For example, training set data may include depth maps of hands and corresponding sensor images of a hand in various gestures, translations, rotations, and depths.

FIG. 8 shows an example of a flow diagram illustrating a process for obtaining a linear regression model. The obtained linear regression model may be applied in operation of an apparatus as described herein. The process 100 begins at block 102 by obtaining training set (of size m) data of pairs of high resolution depth maps (ground truth) and low resolution images for multiple object gestures and positions. Depth maps may be obtained by any appropriate method, such as a time-of-flight camera, optical modeling or a combination thereof. Sensor images may be obtained from the device itself (such as the device of FIG. 3, where each low resolution image is a matrix of values, such values being, for example, the current—indicating scattered light intensity at a given light sensor 33—corresponding to a particular y-coordinate when a light source at a given x-coordinate is sequentially flashed), optical modeling or a combination thereof. To efficiently obtain large training sets, an optical simulator may be employed. In one example, a first set of depth maps of various hand gestures may be obtained from a time-of-flight camera. Tens of thousands of depth maps may be additionally obtained by rotating, translating and changing the distance to surface (depth value) of the first set of depth maps and determining the resulting depth maps using optical simulation. Similarly, optical simulation may be employed to generate tens of thousands of low resolution sensor images that simulate sensor images obtained by the system configuration in question. Various commercially available optical simulators may be used, such as the Zemax optical design program. In generating training set data, the system may be calibrated such that the data is collected only from outside any areas that are inaccessible to the camera or other device used to collect data. For example, obtaining accurate depth information from a time-of-flight camera may be difficult or impossible at distances of less than 15 cm from the camera. As such, a camera may be positioned at a distance greater than 15 cm from a plane designated as the device surface to obtain accurate depth maps of various hand gestures.

The process 100 continues at block 104 by vectorizing the training set data to obtain a low resolution matrix C and a high resolution matrix D. Matrix C includes m vectors, each vector being a vectorization of one of the training low resolution images, which may include values representing signals as received or simulated from the sensor system for all (or a subset) of the low resolution images in the training set data. Matrix D also includes m vectors, each vector being a vectorization of one of the training high resolution images, which may include 0 to 1 grey scale depth map values for all (or a subset) of the high resolution depth map images in the training set data. The process 100 continues at block 106 by performing a linear regression to determine to learn a scaling weight matrix W, with D=W×C. W represents the linear relationship between the low resolution images and high resolution depth maps that may be applied during operation of an apparatus as described above with respect to FIGS. 4 and 5.

FIG. 9 shows an example of a flow diagram illustrating a process for obtaining a non-linear regression model. The obtained non-linear regression may be applied in operation of an apparatus as described herein. The process 110 begins at block 112 by obtaining first reconstructed depth maps from training set data. The training set data may be obtained as described above with respect to block 102 of FIG. 8. In some implementations, block 112 includes obtaining a first reconstructed depth map matrix R1 from R1=W×C, with matrix C and matrix W determined as discussed above with respect to blocks 106 and 108 of FIG. 8. The R1 matrix can then be de-vectorized to obtain m first reconstructed depth maps (R1₁₋ₘ) that correspond to the m low resolution images. In some implementations, the first reconstructed depth maps have a resolution that is higher than the low resolution images. As a result, the entire dataset of low resolution sensor images is upscaled.

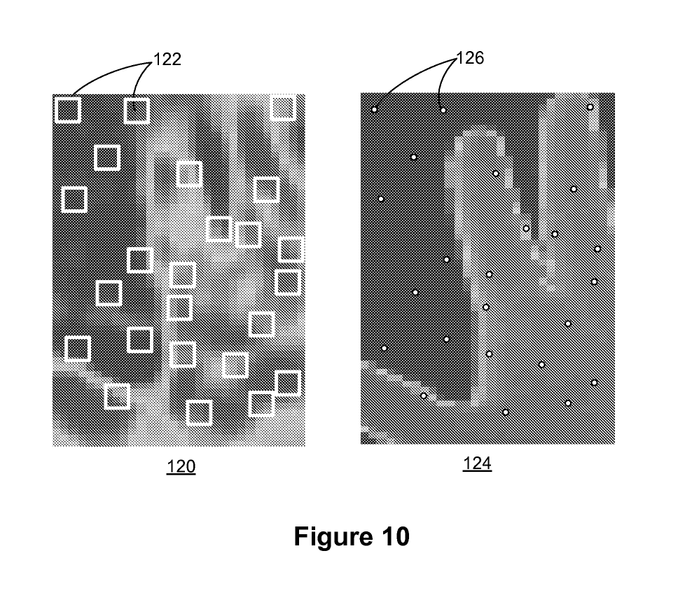

The process 110 continues at block 114 by extracting features from the first reconstructed depth maps. In some implementations, multiple multi-pixel patches are randomly selected from each of the first reconstructed depth maps. FIG. 10 shows an example of a schematic illustration of a reconstructed depth map 120 and multiple pixel patches 122. Each pixel patch 122 is represented by a white box. According to various implementations, the patches may or may not be allowed to overlap. The features may be labeled with the ground truth depth map value of the pixel corresponding to the center location of the patch, as determined from the training set data depth maps. FIG. 10 shows an example of a schematic illustration of center points 126 of a training set depth map 124. The training set depth map 124 is the ground truth image of the reconstructed depth map 120, with the center points 126 corresponding to the multi-pixel patches 122.

If used, the multi-pixel patches can be vectorized to form a multi-dimensional feature vector. For example, a 7×7 patch forms a 49-dimension feature vector. All of the patch feature vectors from a given R1ᵢ matrix can be then be concatenated to perform training. This may be performed on all m first reconstructed depth maps (R1₁₋ₘ).

Returning to FIG. 9, the process continues at block 116 by performing machine learning to learn a non-linear regression model to determine the correlation between the reconstructed depth map features and the ground truth labels. According to various implementations, random forest modeling, neural network modeling or other non-linear regression technique may be employed. In some implementations, for example, random decision trees are constructed with the criterion of maximizing information gain. The number of features the model is trained on depends on the number of patches extracted from each first reconstructed depth map and the number of first reconstructed depth maps. For example, if the training set includes 20,000 low resolution images, corresponding to 20,000 first reconstructed depth maps, and 200 multi-pixel patches are randomly extracted from each first reconstructed depth map, the model can be trained on 4 million (20,000 times 200) features. Once the model is learned, it may be applied as discussed above with reference to FIGS. 4 and 6.

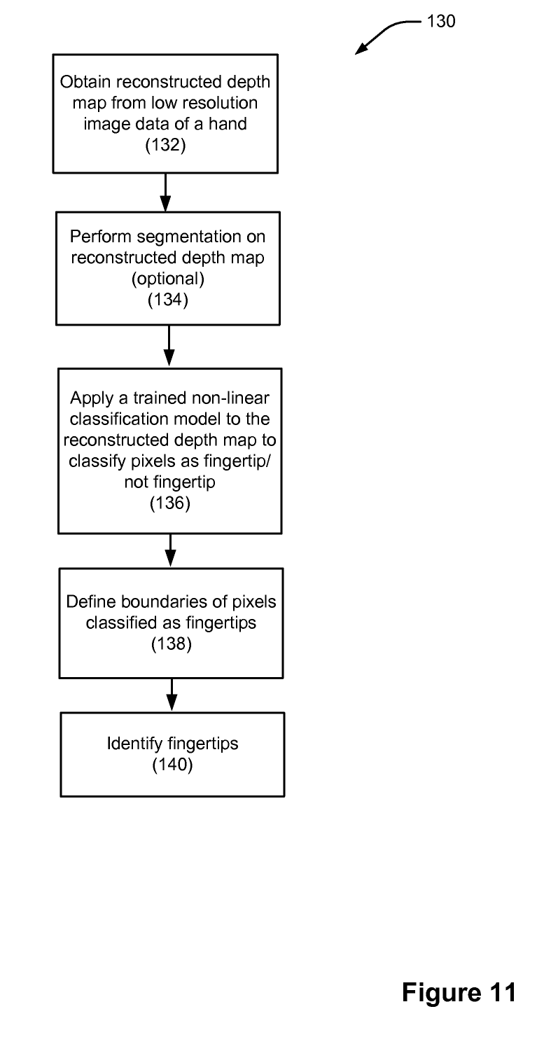

Another aspect of the subject matter described herein is an apparatus configured to identify fingertip locations. The location information can include translation (x, y) and depth (z) information. FIG. 11 shows an example of a flow diagram illustrating a process for obtaining fingertip location information from low resolution image data. The process 130 begins at block 132 with obtaining a reconstructed depth map from low resolution image data. Methods of obtaining a reconstructed depth map that may be used in block 132 are described above with reference to FIGS. 4-10. For example, in some implementations, the second reconstructed depth map obtained in block 66 of FIG. 4 may be used in block 132. In some other implementations, the first reconstructed depth map obtained in block 64 may be used, if for example, block 66 is not performed.

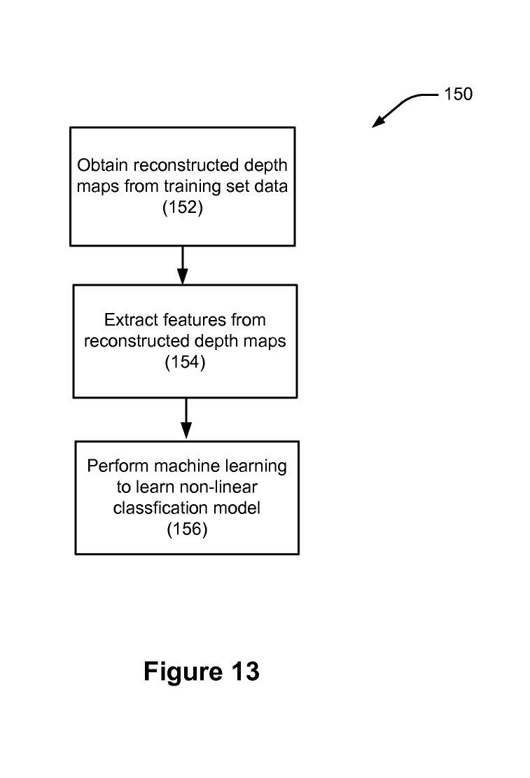

The process 130 continues at block 134 by optionally performing segmentation on the reconstructed depth map to identify the palm area, reducing the search space. The process continues at block 136 by applying a trained non-linear classification model to classify pixels in the search space as either fingertip or not fingertip. Examples of classification models that may be employed include random forest and neural network classification models. In some implementations, features of the classification model can be multi-pixel patches as described above with respect to FIG. 10. Obtaining a trained non-linear classification model that may be applied in block 136 is described below with reference to FIG. 13.

In one example, an input layer of a neural network classification may include a 15×15 patch from a second reconstructed depth map, such that the size of the input layer is 225. A hidden layer of size 5 may be used, with the output layer having two outputs: fingertip or not fingertip.

The process 130 continues at block 138 by defining boundaries of pixels identified as classified as fingertips. Any appropriate technique may be performed to appropriately define the boundaries. In some implementations, for example, blob analysis is performed to determine a centroid of blobs of fingertip-classified pixels and draw bounding boxes. The process 130 continues at block 140 by identifying the fingertips. In some implementations, for example, a sequence of frames may be analyzed as described above, with similarities matched across frames.

The information that can be obtained by the process in FIG. 11 includes fingertip locations, including x, y and z coordinates, as well as the size and identity of the fingertips.

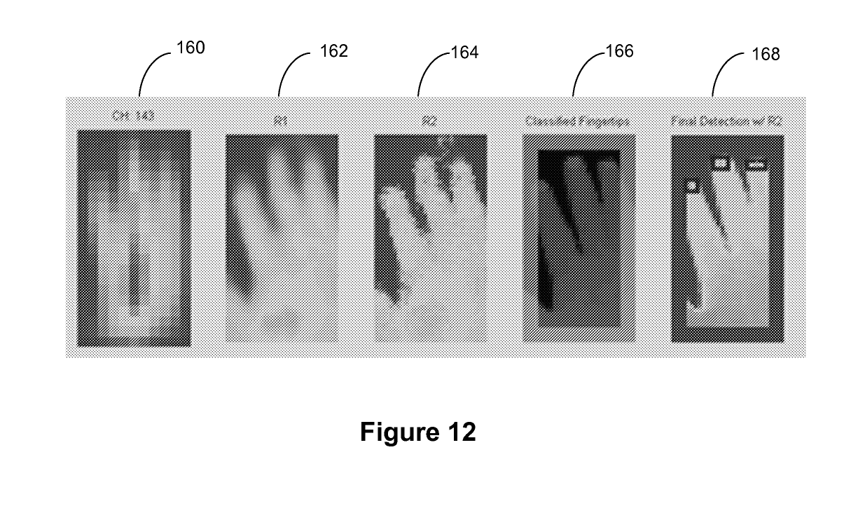

FIG. 12 shows an example of images from different stages of fingertip detection. Image 160 is an example of a low resolution image of a hand gesture that may be generated using a sensor system as disclosed herein. Images 161 and 162 show first and second reconstructed depth maps, respectively, of the low resolution sensor image 160 as obtained as described above using a trained random forest regression model. Image 166 shows pixels classified as fingertips as obtained as described above using a trained random forest classification model. Image 168 shows the detected fingertips as shown with boundary boxes.

FIG. 13 shows an example of a flow diagram illustrating a process for obtaining a non-linear classification model. The obtained non-linear classification model may be applied in operation of an apparatus as described herein. The process 150 begins at block 152 by obtaining reconstructed depth maps from training set data. The training set data may be obtained as described above with respect to block 102 of FIG. 8 and may include depth maps of a hand in various gestures and positions as taken from a time-of-flight camera. Fingertips of each depth map are labeled appropriately. To efficiently generate a training set, fingertips of depth maps of a set of gestures may be labeled with depth map information including fingertip labeling. Further depth maps including fingertip labels may then be obtained from a simulator for different translations and rotations of the gestures.

In some implementations, block 152 includes obtaining second reconstructed depth maps by applying a learned non-linear regression model to first reconstructed depth maps that are obtained from the training set data as described with respect to FIG. 8. The learned non-linear regression model can be obtained as described with respect to FIG. 9.

The process 150 continues at block 154 by extracting features from the reconstructed depth maps. In some implementations, multiple multi-pixel patches are extracted at the fingertip locations for positive examples and at random positions exclusive to the fingertip locations for negative examples. The features are appropriately labeled as fingertip/not fingertip based on the corresponding ground truth depth map. The process 150 continues at block 156 by performing machine learning to learn a non-linear classification model.

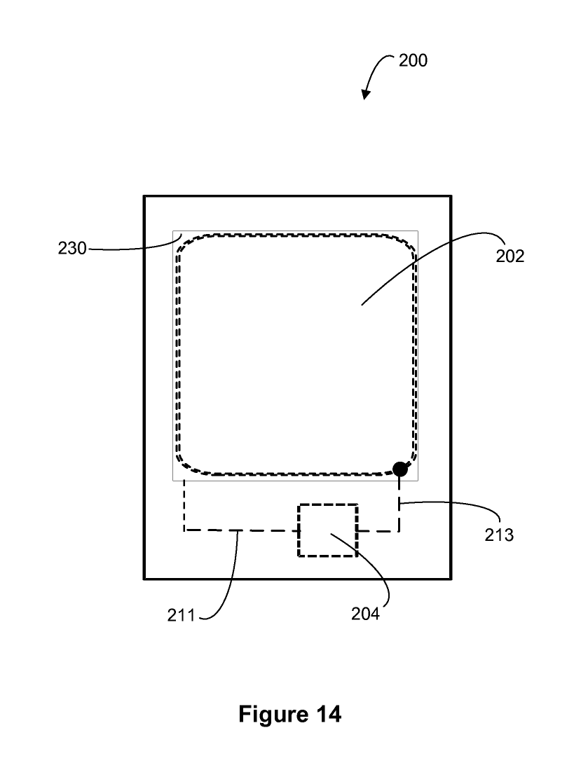

FIG. 14 shows an example of a block diagram of an electronic device having an interactive display according to an implementation. Apparatus 200, which may be, for example a personal electronic device (PED), may include an interactive display 202 and a processor 204. The interactive display 202 may be a touch screen display, but this is not necessarily so. The processor 204 may be configured to control an output of the interactive display 202, responsive, at least in part, to user inputs. At least some of the user inputs may be made by way of gestures, which include gross motions of a user's appendage, such as a hand or a finger, or a handheld object or the like. The gestures may be located, with respect to the interactive display 202, at a wide range of distances. For example, a gesture may be made proximate to, or even in direct physical contact with the interactive display 202. Alternatively, the gesture may be made at a substantial distance, up to, approximately, 500 mm from the interactive display 202.

Arrangement 230 (examples of which are described and illustrated herein above) may be disposed over and substantially parallel to a front surface of the interactive display 202. In an implementation, the arrangement 230 may be substantially transparent. The arrangement 230 may output one or more signals responsive to a user gesture. Signals outputted by the arrangement 230, via a signal path 211, may be analyzed by the processor 204 as described herein to obtain reconstructed depth maps, identify fingertip locations, and recognize instances of user gestures. In some implementations, the processor 204 may then control the interactive display 202 responsive to the user gesture, by way of signals sent to the interactive display 202 via a signal path 213.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that can be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
an interface for a user of an electronic device having a front surface including a detection area;
a plurality of detectors configured to detect interaction of an object with the device at or above the detection area and output signals indicating the interaction, wherein an image can be generated from the signals; and
a processor configured to:
obtain image data from the signals;
apply a linear regression model to the image data to obtain a first reconstructed depth map, wherein the first reconstructed depth map has a higher resolution than the image; and
apply a trained non-linear regression model to the first reconstructed depth map to obtain a second reconstructed depth map.

2. The apparatus of claim 1, further comprising one or more light-emitting sources configured to emit light, wherein the plurality of detectors are light detectors and the signals indicate interaction of the object with light emitted from the one or more light-emitting sources.

3. The apparatus of claim 1, further comprising:
a planar light guide disposed substantially parallel to the front surface of the interface, the planar light guide including:
a first light-turning arrangement that is configured to output reflected light, in a direction having a substantial component orthogonal to the front surface, by reflecting emitted light received from one or more light-emitting sources; and
a second light-turning arrangement that redirects light resulting from the interaction toward the plurality of detectors.

4. The apparatus of claim 1, wherein the second reconstructed depth map has a resolution at least three times greater than the resolution of the image.

5. The apparatus of claim 1, wherein the second reconstructed depth map has the same resolution as the first reconstructed depth map.

6. The apparatus of claim 1, wherein the processor is configured to recognize, from the second reconstructed depth map, an instance of a user gesture.

7. The apparatus of claim 6, wherein the interface is an interactive display and wherein the processor is configured to control one or both of the interactive display and the electronic device, responsive to the user gesture.

8. The apparatus of claim 1, wherein the apparatus does not have a time-of-flight depth camera.

9. The apparatus of claim 1, wherein obtaining image data comprises vectorization of the image.

10. The apparatus of claim 1, wherein obtaining a first reconstructed depth map includes applying a learned weight matrix to vectorized image data to obtain a first reconstructed depth map matrix.

11. The apparatus of claim 1, wherein apply a non-linear regression model to the first reconstructed depth map includes extracting a multi-pixel patch feature for each pixel of the first reconstructed depth map to determine a depth map value for each pixel.

12. The apparatus of claim 1, wherein the object is a hand.

13. The apparatus of claim 12, wherein the processor is configured to apply a trained classification model to the second reconstructed depth map to determine locations of fingertips of the hand.

14. The apparatus of claim 13, wherein the locations include translation and depth location information.

15. The apparatus of claim 1, wherein the object is a stylus.

16. An apparatus comprising:
an interface for a user of an electronic device having a front surface including a detection area;
a plurality of detectors configured to receive signals indicating interaction of an object with the device at or above the detection area, wherein an image can be generated from the signals; and
a processor configured to:
obtain image data from the signals;
obtain a first reconstructed depth map from the image data, wherein the first reconstructed depth map has a higher resolution than the image; and
apply a trained non-linear regression model to the first reconstructed depth map to obtain a second reconstructed depth map.

17. The apparatus of claim 16, further comprising one or more light-emitting sources configured to emit light, wherein the plurality of detectors are light detectors and the signals indicate interaction of the object with light emitted from the one or more light-emitting sources.

18. The apparatus of claim 16, further comprising:
a planar light guide disposed substantially parallel to the front surface of the interface, the planar light guide including:
a first light-turning arrangement that is configured to output reflected light, in a direction having a substantial component orthogonal to the front surface, by reflecting emitted light received from one or more light-emitting sources; and
a second light-turning arrangement that redirects light resulting from the interaction toward the plurality of detectors.

19. A method comprising:
obtaining image data from a plurality of detectors arranged along a periphery of a detection area of a device, the image data indicating an interaction of an object with the device at or above the detection area;
obtaining a first reconstructed depth map from the image data, wherein the first reconstructed depth map has a higher resolution than the image; and
obtaining a second reconstructed depth map from the first reconstructed depth map.

20. The method of claim 19, wherein obtaining the first reconstructed depth map includes applying a learned weight matrix to vectorized image data.

21. The method of claim 20, further comprising learning the weight matrix.

22. The method of claim 21, wherein learning the weight matrix includes obtaining training set data of pairs of depth maps and images for multiple object gestures and positions, wherein the resolution of the depth maps is higher than the resolution of the images.

23. The method of claim 19, wherein obtaining a second reconstructed depth map includes applying a non-linear regression model to the first reconstructed depth map.

24. The method of claim 23, wherein applying a non-linear regression model to the first reconstructed depth map includes extracting a multi-pixel patch feature for each pixel of the first reconstructed depth map to determine a depth map value for each pixel.

25. The method of claim 24, further comprising learning the non-linear regression model.

26. The method of claim 19, wherein the second reconstructed depth map has a resolution at least three times greater than the resolution of the image.

27. The method of claim 19, wherein the object is a hand.

28. The method of claim 27, further comprising applying a trained classification model to the second reconstructed depth map to determine locations of fingertips of the hand.

29. The method of claim 28, wherein the locations include translation and depth location information.
